(19) United States
(12) Patent Application Publication
(10) Pub. No.: US 2018/0291308 A1
(43) Pub. Date: Oct. 11, 2018

(54) Candle Making Apparatus

(71) Applicant: VOTIVE LIMITED, Auckland (NZ)

(72) Inventor: Brian Simpson, Auckland (NZ)

(21) Appl. No.: 15/949,099

(22) Filed: Apr. 10, 2018

(30) Foreign Application Priority Data
Apr. 10, 2017 (NZ) 730927

(51) Int. Cl. C11C 5/02; C11C 5/00; B05B 11/00; B01F 3/08; B01F 3/10; B01F 7/00; B01F 7/16; B01F 15/00; B01F 15/06

(52) U.S. Cl. CPC C11C 5/02; C11C 5/002; C11C 5/004; B05B 11/0002; B01F 3/0853; B01F 2215/0067; B01F 7/00008; B01F 7/16; B01F 15/00175; B01F 15/065; B01F 2015/062; B01F 3/10

(57) ABSTRACT

Disclosed is a candle making apparatus including an electric appliance for a process of sequentially melting, mixing and holding the constituents of a container candle inside a jug and at a molten temperature until a user is ready to pour the melt into a container. Typically the constituents of such candles include vegetable wax, soy products, vegetable oils, fats or fatty acids. They are melted at a higher temperature, then mixed, and cooled so that volatile ingredients can be added at a lower temperature while the mixture remains melted, and is further stirred. The process is controlled by a microprocessor. A visual interface displays progress and accepts user input.

### FIELD

Apparatus for melting wax or vegetable oils or fats or fatty acids, and physically mixing the materials at under a time- and temperature-regulated process for making candles; preferably as “container candles” in which the melted materials are poured into and solidify inside vitreous containers.

### BACKGROUND

People wish to make their own candles, especially candles including fragrant oils, with selected sizes, shapes, colours, and scents. The typical starting material for making what is here referred to collectively as “wax” is not the traditional tallow, beeswax or paraffin wax but a combination of vegetable wax, soy products, vegetable oils, fats or fatty acids, together having a melting point above room temperature. Paraffin wax and blended wax are options, if of an appropriate melting point. An action requiring close control of temperature is the addition of volatile fragrances. It is useful to review two relevant methods for making candles; casting, and container candles.

For casting a wick is clamped into a form to be filled with melted materials. After the wax has cooled down and solidified, the form is opened and the finished candle can be removed for later use. A container candle is a non-flammable container filled with wax and including a wick. The cooled wax may be soft and is normally not decanted from the container, but will be burnt within the container. The candle wax is consumed within the container so the combination is a bit like a candle and a candle holder rolled into one. They never drip. Because the wax is in a container, lower melting point waxes (soy etc.) that enhance scent throw are able to be used. That gives scented container candles the ability to effectively throw more scent than their free-standing counterparts.

In previous methods, actually melting the material can be a safety hazard owing to the use of boiling water. Skill is required to properly control the temperature of the ingredients during mixing since incorrect temperatures can damage the raw ingredients and adversely affect the performance of the finished candle. In particular, the addition of volatile fragrances near the end of a sequence requires close control of temperature. The patent literature relates in the main to molds or other ways to shape a candle, and ways to implant a wick within a candle.

U.S. Pat. No. 6,412,670 describes candle making apparatus for melting wax in a first chamber, to flow into a dispensing chamber, from which the wax can be released as a controlled amount into a mold.

US2009/0092938 describes a candle maker and redresser in which wax from used candles is recovered by melting into either a container or into a mold.

U.S. Pat. No. 8,887,628 describes a jug with a heating base and a stirrer; a “boil dry” thermostat (column 1 line 35) and a second thermostat in thermal contact with the bottom of the jug for maintaining a temperature of about 60° C. during a foaming process for a food. There is also a physical sensor (the “handspike”) for detecting presence of a jug on the heating base. '628 names a “controller” but does not give it any obvious function (see column 1 lines 37-38). The cup device of '628 has three functions (as per claim 1): it heats a liquid food to about 60° C., it stirs the liquid food at the controlled temperature, and it causes the liquid food to become foamed. That suggests that the stirring (using the well-known “magnetic flea” principle) is sufficiently vigorous to mix air into the liquid food. There is no reference to a timed operation or a sequence of temperatures in '628, which is not intended as a candle making appliance. Note that in the present invention, use of the analogue temperature sensor known as a thermistor in conjunction with analogue-to-digital conversion within a microprocessor allows a number of regulated temperatures to be used in a sequence of purpose-related states.

### OBJECT

An object of this invention is to provide a single appliance for heating and mixing ingredients for use in making candles inside molds, or at least to provide the public with a useful choice.

### STATEMENT OF INVENTION

In a first broad aspect this invention provides an electrical appliance for preparing a melted substance as a candle material for a candle that includes wax or equivalents, optional fragrances, optional colorants, wherein the appliance comprises a base and a detachable mixing jug; the base including a controlled heating surface, an analogue temperature sensor, a controlled stirrer motor, power control means and a controlled user interface panel, operationally connected to a programmable digital controller herein referred to as a MCU, the detachable mixing jug including a rotatable magnetic stirrer; the appliance, when in use, melts and mixes the candle material contained within the detachable mixing jug, and optional added material, according to a predetermined routine comprising a programmed series of states using more than one controlled temperature.

Preferably the detachable mixing jug has a detachable lid and a thermally non-conductive handle and a thermally conductive base including a mixing device capable, when in use, of stirring but not causing a froth in the candle material when molten; the mixing device comprising a magnetic flea fixed within the base.

Preferably the detachable mixing jug and the base comprise two parts of a stirring mechanism; the base including a motor and permanent magnet for rotating a magnetic field and the jug including a magnetised, rotatable stirring object which, when the container is on the base, is held within the magnetic field; thereby being capable when in use of agitating and thereby mixing the contents of the container.

Optionally the base includes control means responsive to motion of the magnetic stirrer, thereby determining whether the contents of the container are solid or are liquid, or if the container is empty.

Preferably the analogue temperature sensor includes in combination a thermistor maintained, when in use, in physical contact with an area of a base of the mixing jug and electrically connected to an input of the MCU capable when in use of interpreting an analogue voltage derived from a resistance of the thermistor as indicative of a temperature within the mixing jug.

Preferably the MCU comprises a microprocessor capable of enacting at least one programmed series of states and the series of states are encoded within a non-volatile program memory.

Preferably the user interface panel comprises a line of controllable lamps capable when in use of progress through the series of states when controlled by the MCU; at least one of said controllable lamps comprising a user-controllable switch.

In a related aspect the programmed series of states preferably includes State 1; awaiting a user's “start” command after the jug, loaded with wax has been placed upon the base by the user; State 2 for controllably heating the jug to a first temperature over at least a minimum time; State 3 for controllably heating the jug to a second temperature while controllably operating the stirrer; State 4, maintaining the temperature for a time and operating the stirrer; State 5, allowing the temperature of the jug to fall to a lower temperature and then maintaining that lower temperature while awaiting the user's “continue” command after adding the optional materials; State 6; maintaining the lower temperature and operating the stirrer; and State 7; maintaining the jug temperature for an extended time until the user removes the jug; whereupon the MCU is reset.

### PREFERRED EMBODIMENT

The description of the invention to be provided herein is given purely by way of example and is not to be taken in any way as limiting the scope or extent of the invention. In particular the dimensions shown in one illustration are purely illustrative. The invention has been described in an illustrative manner, and it is to be understood that the terminology which has been used is intended to be in the nature of words of description rather than of limitation.

In this specification, reference numerals are provided for clarification only and are not intended to restrict the scope of the invention to the particular embodiments of the components in conjunction with which the reference numerals are used.

Throughout this specification unless the text requires otherwise, the word “comprise” and variations such as “comprising” or “comprises” will be understood to imply the inclusion of a stated integer or step or group of integers or steps but not the exclusion of any other integer or step or group of integers or steps. Each document, reference, patent application or patent cited in this text is expressly incorporated herein in their entirety by reference. Reference to cited material or information cited in the text should not be understood as a concession that the material or information was part of the common general knowledge or was known in New Zealand or in any other country.

### DRAWINGS

FIG. 1: is a sectional view of the appliance.

FIG. 2: is an oblique, exploded view of the appliance.

FIG. 3: shows a preferred layout for the control panel.

FIG. 4: is a plan view of the base including the thermistor and housing for the stirring motor.

FIG. 5 is a partial circuit diagram showing wiring between the thermistor and the MCU.

### EXAMPLE 1

The invention is an electrical appliance also known as a “Mini Melter”™. It is pre-programmed to make specific items a predetermined routine; for example scented soy candles in a glass jar by heating, melting and stirring amounts of selected waxes, butters, oils, with optional ingredients including fragrances, flavourings, and colourings and, while controlling the temperature of the container and contents according to a predetermined sequence in order to make candles, soap, lotions and balms.

The appliance as shown as 100 in FIG. 2 is intended for non-specialist use and is limited to at most 500 ml of melted wax. An included microprocessor or controller is programmed to provide at least one sequence of process states in accordance with the steps required when preparing a typical fragrance-bearing container candle so removing the need for much of the equipment used in the traditional craft method of making said products or the need for specialist knowledge. The process terminates in a cooled yet still melted state for an indefinite period while awaiting the user to take the jug and pour its contents into a container, preferably a glass container, supporting a wick. The candle may remain within the container, during use.

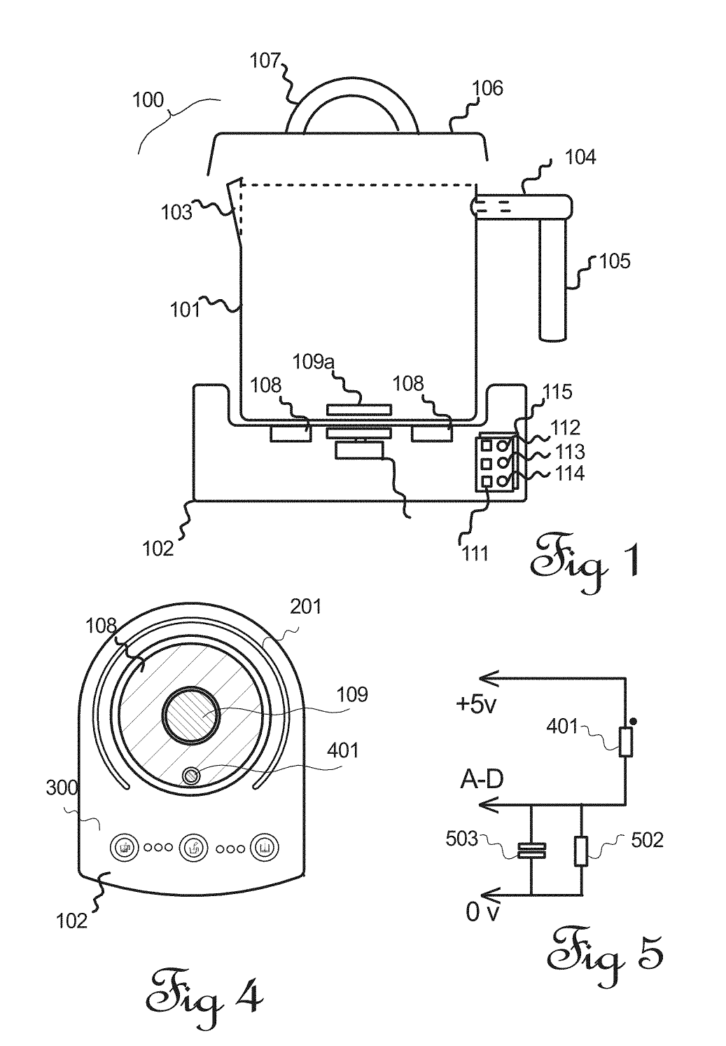

FIG. 1 is a sectional diagram specifically of an earlier embodiment in relation to the interface display. The appliance 100 has a broad base part 102 including the dedicated control means to be described in this specification. The base includes an 80 mm diameter conductive heating element 108 serving as a heatable surface for receiving jug 101 which has a capacity of about 500 ml, and a control panel 111-115 (see also an improved layout 300 in FIGS. 2, 3 and 4). The base includes electric power control and heat regulation means including a microprocessor or equivalent digital control device, an analogue temperature sensor such as a thermistor, a stirrer motor drive and a jug sensor.

The removable cylindrical jug 101 includes a pouring spout 103 and a removable lid 106. Preferably the lid makes a close fit over the jug when in place in order to confine volatiles during use. The lid has a thermally non-conductive handle 107 while the body of the jug includes a secure handle on projection 104; for example a sturdy, fixed cylindrical wooden rod 105. It is important that the user is not exposed to sudden pain arising from inadvertent contact with a hot jug or hot wax, which may cause accidents. The jug is mostly coated with preferably a ceramic coating.

The base at least, of the jug is thermally conductive. The preferred embodiment comprises an 80 mm diameter flat bare aluminium bottom surface to be brought into thermal contact with the heating element 108 and with the thermistor 401 (see FIG. 4) when in use. Note that the thermistor is thermally separated sideways from the heater within the annular heated conductive base 108 which surrounds a motor drive 109 including a rotatable magnet, coupled when in use to an adjacent magnetic flea stirrer 109a, fixed inside the jug. The motor drive is mounted to be vertically resiliently moveable in relation to the base 108 and includes a pressure switch (not shown) to hold the MCU in a reset mode when the jug 101 is not on the base 102. The MCU, described below, includes non-volatile memory holding at least one program to control the various stages of the production process; preferably to make single, large scented soy candles each to be molded in a glass jar serving as a candle container.

FIG. 2 shows a perspective view of the appliance 100, including a safety rail 201 around the upwardly directed heating element 108 within the base. The in-jug portion of the magnetic flea type stirrer 109 is shown. A power cord 303 connects the applies to a supply of utility electricity. The control panel 300 is described later.

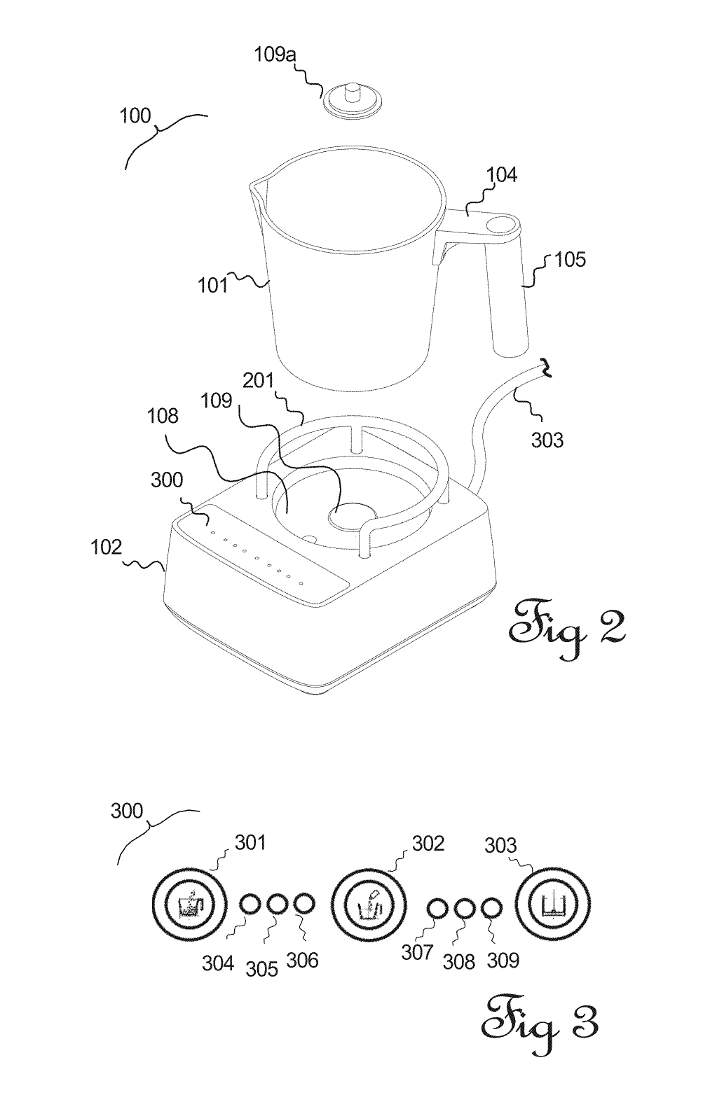

FIG. 3 shows a preferred layout for a combination control panel and indicator array, mapping the status of the process as a series of states into a left-to-right progression of lit LEDs. The large circles including symbols 301, 302 and 303 are capacitive switches triggered by touch that include controlled light-emitting diodes (Leds) (or other lamps) combined. They include symbols for melting wax, for mixing in fragrances, and becoming ready to pour. In the present version a red Led and a blue Led are driven ON to produce a purple light effect. The small circles in FIG. 3—indicated by 304-309 are controlled Leds only. Typically they are white Leds. The process for melting wax, for mixing in fragrances, and ready-to-pour, at the completion of the mixing process appears to move across the control panel from left to right.

FIG. 4 is a plan view of the base 102 of the appliance, including the heating element 108, the central stirring assembly 109, and the physical cap of the thermistor 401. The thermistor temperature is mainly influenced by contact with the thermally conductive base of the jug 101, and the thermistor is thermally separate from the heating element 108.

A microprocessor or equivalent (abbreviated to MCU in the following text) is used in the present invention, to accept a range of inputs including user switches, make decisions according to a pre-loaded program held in a memory, and provide a range of outputs in order to put the inventor's concepts into practice. At this time the selected MCU is a commonly available CMOS type: PIC16F1516-I/SS (Microchip) although other options may be acceptable.

The following description of connections to the microprocessor enables a person skilled in the relevant arts and having familiarity with a given type of microprocessor to construct a physical circuit and, given a series of desired operations (as described below) as a series of states, to write a set of code instructions for controlling the or any appropriate microprocessor. The base of the appliance includes a +12 volt 500 mA switched mode DC power supply; its output reduced in voltage through a 78L05 regulator to +5 volts for the MCU. Also, a separate discrete switch may be wired to directly interrupt mains heating power whenever the jug is taken off the base of the appliance, in part as a safety precaution in case the MCU is not responsive.

Inputs:

Inputs to the MCU include:
a) User inputs into three of the ports—as contact made by touching one of the three illuminatable control switches 301, 302 and 303 included in a control panel (FIG. 3).
b) Time, for example as a count of microprocessor clock cycles which by default are at 31 kHz, or from a dedicated integrated circuit, or by using the frequency of the AC mains supply.
c) Jug 101 presence, using a pressure switch that may be pushed down and held closed by the weight of the jug upon the heating surface. The flea motor housing 109 which is resiliently mounted provides a suitable platform for the switch. A preferred procedure is to hold the MCU in “reset” mode” whenever the jug presence switch indicates “no jug”, thereby minimising risk of inadvertent heating.
d) Temperature of the jug 101 contents. A temperature-dependent resistance, preferably a negative temperature coefficient thermistor (type XH-2P nominal 10 K ohms) is resiliently mounted so as to be pushed into physical and thermal contact with the base when the jug is placed upon the heating element. At the same time the thermistor is in minimal sideways thermal contact with the heating element that is also in contact with the base of the jug. It will be appreciated that jug base contact temperature is an approximation to the temperature of the interior contents of the jug. The thermistor provides an analogue correlate of temperature, unlike a thermostat which is either closed or open at a predetermined temperature. As shown in FIG. 5, a partial circuit diagram showing wiring for the thermistor, the thermistor 401 is connected at one end to an internal regulated 5 volt supply, and at the other end to a 4.7 kilohm resistor 502 in parallel with a 100 nanofarad capacitor 503 that are in turn connected to a zero volts line. An analogue-capable input port (A-D) of the MCU is connected to the junction between the thermistor resistance and the fixed resistance, at which junction the voltage will vary at around +2.5 volts according to temperature. A temperature between 20° C. and at least 100° C. can be read as an analogue-to-digital conversion at a ten-bit resolution (that is provided within the preferred MCU) at any time. The stored program includes constants reflecting desired temperatures. Other ways to convert a thermistor resistance into a number related to a temperature will be known to those skilled in the art. Note that manufacturing tolerances of thermistors and resistors and the indirect measurement method described mean that the specified temperatures as described in this specification may not be exactly those within the jug.

Outputs:

The outputs driven by the MCU include:
a) User interface 300: see the description (above) for FIG. 3. Sufficient power to drive any one Led lamp is obtained from an allocated MCU port through a typically 220 ohms series resistor for limiting the current. All the Leds form one row and are activated in order from left to right as a visual indication during operation of the program.
b) Heat: A digital output—mediated through a relay or TRIAC (solid-state switch) or an equivalent—is used for controlling utility power supplied to the heater element. In the preferred embodiment, a port of the MCU supplies current to the base of a NPN power transistor type S8050; the collector of which is wired to a 12-volt supply through the coil of a relay to close the normally-open relay switch when the transistor conducts. It is perhaps safer to maintain the power ON by repeated positive actions taken by the MCU in case any situation might arise in which the heater element turned on but the MCU is for any reason not responsive to the program that it is executing. In addition the selected MCU chip includes a watchdog program facility. The load within the jug is flammable. A low-melting point fuse device under the base of the jug may be required by safety ordinances.
   In the preferred process, the relatively powerful heater element is restrained by operating it under a selected duty cycle (such as 3 seconds on, 1 second off or 1 second on, 1 second off) in order to provide a simulation of proportional control, as determined by the particular state of the melting/mixing program that is being executed. While the jug base is too hot, heat is not supplied at all. It may be preferred that a directly wired switch always disconnects the heater element from the power supply when the jug is lifted off since the thermistor depends on heat transfer through the base of the jug (when present) from the jug contents.
c) Alerts: An audible signal generator is included to make sounds to alert the user at particular stages, using a self-contained piezo buzzer such as type CT-1205-SMT (CUI, Inc) operational at the 5-volt voltage used in the MCU circuit. A power FET transistor capable of switching at least 50 mA is used to buffer the MCU port used for buzzer control.
d) Stirring: Provide power, from time to time, to cause a motor 109 carrying a permanent magnet having a field that can enter the base of the jug, used to stir the contents of the jug via a permanently installed internal magnetic flea 109a to turn when required. A medium power field-effect transistor is preferred to control the selected 12-volt motor power.

Process:

This example sequence incorporates a Led status display integrated with capacitive button 255 switches (301-303) also including Leds. In this embodiment a sequence of 8 States is described.

The appliance takes on State 1 when the power is connected (starting with the “power-on reset”) and proceeds through the following 7 states when carrying out a candle melting sequence.
1. State 1: The switch control LEDs 301, 302 and 303 flash briefly and an audible “welcome” alert is produced to indicate that the unit is powered on. State 1 comprises waiting indefinitely for a user's “start” command after a jug, loaded with an amount of candle material (a type of wax) as supplied in solid form (but not with any volatile fragrances which are added later) is placed on the heater. Note: Replacing or removing the jug before state 2 has commenced does not affect the process. After the process starts, removing the jug halts heating. State 1 is indicated by flashing the switch and lamp 301 at the left side of the panel. (Flashing” means 1 second ON, 2 seconds OFF, repeatedly).
2. When the switch of 301 is pressed by the user, State 2 is begun. This section heats the jug to an end-point of 68° C. over about 7-10 minutes. State 2 is indicated by flashing the lamp 304. (The stirrer would not bet useful with solid contents.)
3. State 3: illuminate lamp 304, and after a 20 sec delay heat the jug to a further end-point of 75° C. over about 7-10 minutes. During this time the MCU will operate the stirrer intermittently such as with a 2 sec on; 5 sec off duty cycle. State 3 is indicated by flashing lamp 305. During States 2 and 3 the solid wax will become melted. If either: at least 1 minute has passed since the temperature reached 68° C. or: the temperature has now reached 75° C., the MCU will enter State 4.
4. In State 4, lamp 305 is illuminated and the jug is held at about 75° C. for about 7-10 minutes. During this time operate the stirrer continuously for preferred effective and complete mixing. State 4 is indicated by flashing of lamp 306.
5. In State 5, lamp 306 is lit, and the temperature of the jug is allowed to fall to about 60-62° C. (or another temperature appropriate for the essential oils of the fragrances) and then maintain that temperature. When that end-point is reached, lamp 302 (which bears a symbol representing mixing) is lit with a series of flashes and an audible beep, to show that the appliance is ready to accept an amount of fragrances. (Many fragrances are comprised of volatile oils which tend to evaporate at higher temperatures. Design of the process takes those properties into account in order to produce an effective mixing of the wax and the fragrance throughout the contents of the jug). The user adds the fragrance(s) and presses switch 302.
6. When the switch at lamp 302 is pressed State 6 begins. The lamp in switch 302 is lit and the program continues to maintain that temperature and operates the stirrer intermittently for ten minutes. State 6 is indicated by flashing lamp 307.
7. State 7 is commenced when the jug temperature has dropped to 62° C. This State is the final “ready to pour” phase. The MCU repeatedly flashes the lamp 303 and creates an audible beep, to show the user that the contents of the jug are ready to be poured into a receiving container. In State 7 the jug temperature is maintained at the final temperature since the user may not be present at the time. (The appliance has an auto shut off function if inadvertently left on for long periods.) Preferably, the heater is switched on if the jug temperature drops below 60° C. and off when it reaches or exceeds 62° C.
8. State 8: when the jug 101 has been removed, as indicated by the jug weight switch, the heating process is halted by resetting the MCU. At this time the user will be pouring the melted and stirred mixture into one or more containers or molds.

Variations:

The States as described in the embodiment above may be re-programmed in order to operate with “waxes” having other melting points or more or less volatile additives, by changing the program stored in flash memory inside the MCU. For example, temperatures, stirring, and times may be altered. Thanks to use of a thermistor, any practical temperature between room temperature and typically 100° C. (as a safe limit) can be selected.

Rather than an electromechanical relay, a solid-state AC mains control including a zero-crossing detector and an optical isolator may be used; for instance type MOC3041 (Motorola) with a TRIAC, as well-known in the electronic arts.

The preferred MCU has capacity for holding and performing any one of a range of procedures as separate programs in which different sequences of states are run, in order to suit particular materials and requirements. Selection of a particular program may be made by the user from the interface panel by known means such as by holding down one or more switches while the power is turned on.

### RESULTS AND ADVANTAGES

The “Mini Melter™” appliance has at least the following advantages:
It is optimised for home use for making a “container candle” optionally including one or more added fragrances. The preferred composition typically has a lower melting point than that of ordinary candles made of paraffin wax.
It gives consistent results and does not require expertise.
It is safer than options such as using a saucepan on a stove, especially a gas stove.
The appliance is durable and suitable for use in a kitchen environment

Finally it will be understood that the scope of this invention as described and/or illustrated herein is not limited to the specified embodiments. Those of skill will appreciate that various modifications, additions, known equivalents, and substitutions are possible without departing from the scope and spirit of the invention as set forth in the following claims.

1. An electrical appliance for preparing a melted substance as a candle material for a candle that includes wax or equivalents, optional fragrances, optional colorants, wherein the appliance comprises a base and a detachable mixing jug; the base including a controlled heating surface, an analogue temperature sensor, a controlled stirrer motor, power control means and a controlled user interface panel, operationally connected to a programmable digital controller herein referred to as a MCU, the detachable mixing jug including a rotatable magnetic stirrer; the appliance, when in use, melts and mixes the candle material contained within the detachable mixing jug and optional added material according to a predetermined routine comprising a programmed series of states using more than one controlled temperature.

2. The electrical appliance as claimed in claim 1 wherein the detachable mixing jug has a detachable lid and a thermally non-conductive handle and a thermally conductive base including a mixing device capable when in use of stirring the candle material when molten; the mixing device comprising a magnetic flea fixed within the base.

3. The electrical appliance as claimed in claim 1, wherein the analogue temperature sensor comprises a thermistor maintained, when in use, in physical contact with an area of a base of the mixing jug and electrically connected to an input of the MCU capable when in use of interpreting an analogue voltage derived from a resistance of the thermistor as indicative of a temperature within the mixing jug.

4. The electrical appliance as claimed in claim 1, wherein the MCU comprises a microprocessor capable of enacting at least one programmed series of states, and the series of states are encoded within a non-volatile program memory.

5. The electrical appliance as claimed in claim 1, wherein the user interface panel comprises a line of controllable lamps capable when in use of indicating progress through the series of states when controlled by the MCU; at least one of said controllable lamps comprising a user-controllable switch.

6. The electrical appliance as claimed in claim 4 wherein the programmed series of states includes State 1; awaiting a user's “start” command after the jug, loaded with wax has been placed upon the base by the user; State 2 for controllably heating the jug to a first temperature over at least a minimum time; State 3 for controllably heating the jug to a second temperature while controllably operating the stirrer; State 4, maintaining the temperature for a time and operating the stirrer; State 5, allowing the temperature of the jug to fall to a lower temperature and then maintaining that lower temperature while awaiting the user's “continue” command after adding the optional materials; State 6; maintaining the lower temperature and operating the stirrer; and State 7; maintaining the lower temperature for an extended time until the user removes the jug; whereupon the MCU is reset.
